(19) United States
(12) Patent Application Publication
(10) Pub. No.: US 2022/0010501 A1
(43) Pub. Date: Jan. 13, 2022

(54) SYSTEMS AND METHOD FOR HEATING A CONCRETE SLAB AND FOR PREVENTING ACCUMULATION OF MELTABLE PRECIPITATION THEREON

(71) Applicant: UNIVERSITE LAVAL, Quebec (CA)

(72) Inventors: Raphael FULHAM-LEBRASSEUR, Québec (CA); Luca SORELLI, Quebec (CA); David CONCIATORI, Québec (CA); Martin LAPOINTE, Québec (CA)

(21) Appl. No.: 17/293,576

(22) PCT Filed: Nov. 12, 2019
(86) PCT No.: PCT/CA2019/051606

§ 371 Date: May 13, 2021

Related U.S. Application Data
(60) Provisional application No. 62/767,529, filed on Nov. 15, 2018.

(51) Int. Cl. E01C 11/26; H05B 3/28

(52) U.S. Cl. CPC E01C 11/265; H05B 3/286; H05B 2214/02; H05B 2203/026; H05B 2203/014

(57) ABSTRACT

There is described a system for preventing accumulation of meltable precipitation on a surface. The system generally has: a concrete slab having a slab body with a top surface opposed to a bottom surface, the slab body having electrically conductive concrete; a plurality of elongated electrodes within said slab body, a first set of said elongated electrodes being spaced apart from one another proximate to said top surface and a second set of said elongated electrodes being spaced apart from one another away from said elongated electrodes of said first set, the elongated electrodes of the first set being interspersed with the elongated electrodes of the second set; and a voltage source being electrically connected to the elongated electrodes and being operable to apply a voltage to said elongated electrodes, thereby generating heat within said slab body for melting said accumulation on said top surface.

### FIELD

The improvements generally relate to concrete slabs and more specifically relate to heating or preventing accumulation of meltable precipitation such as snow, ice, graupel and/or hail on such concrete slabs.

### BACKGROUND

Accumulation of snow or ice on infrastructures such as roads or bridges is understandably undesirable in at least some situations. To remove such accumulation of snow or ice, it was known to spread salt on the infrastructures in order to melt the snow or ice or to mechanically removed the snow or ice using snow plow trucks. Although such snow or ice removal techniques are satisfactory to a certain extent, there remains room for improvement, especially as such techniques can be costly and time consuming, and can lack effectiveness in at least some situations (e.g., salt is ineffective below a given temperature).

### SUMMARY

In an aspect of this disclosure, there is described a concrete slab having electrically conductive concrete, and a plurality of elongated electrodes distributed in the electrically conductive concrete. It was found that when the elongated electrodes are distributed in a zig-zag distribution in the thickness of the concrete slab, electrical current flowed diagonally from one elongated electrode to another can efficiently generate heat within the slab, which can in turn melt any accumulation of snow, ice, graupel and/or hail lying thereon. It was found that such concrete slab can be less sensitive to loss of efficiency due to possible concrete shrinkage cracking. Moreover, the electrical consumption of the concrete slab with the proposed configuration of electrodes may not be affected by the requirements on the surface of the concrete slab. Accordingly, the concrete slab presented herein can be scaled at any size with same electrical consumption for unit area.

In accordance with a first aspect of the present disclosure, there is provided a system for preventing accumulation of meltable precipitation on a surface, the system comprising: a concrete slab having a slab body with a top surface opposed to a bottom surface, the slab body having electrically conductive concrete; a plurality of elongated electrodes within said slab body, a first set of said elongated electrodes being spaced apart from one another proximate to said top surface and a second set of said elongated electrodes being spaced apart from one another away from said elongated electrodes of the first set, the elongated electrodes of the first set being interspersed with the elongated electrodes of the second set; and a voltage source being electrically connected to the elongated electrodes and being operable to apply a voltage to said elongated electrodes, thereby generating heat within said slab body for melting said accumulation on said top surface.

Further in accordance with the first aspect of the present disclosure, the system can for example comprise a meltable precipitation sensor being configured for sensing said accumulation of meltable precipitation on said top surface; and a controller being communicatively coupled to the voltage source and to the meltable precipitation sensor, the controller having a processor and a memory having stored thereon instructions that when executed by the processor cause the voltage source to apply the voltage to said elongated electrodes upon said sensing.

Still further in accordance with the first aspect of the present disclosure, the meltable precipitation sensor can for example be a snow/ice sensor.

Still further in accordance with the first aspect of the present disclosure, said meltable precipitation sensor can for example be made integral to said concrete slab, and has a sensing surface being exposed at the top surface of said slab body.

Still further in accordance with the first aspect of the present disclosure, wherein the elongated electrodes of the first set can for example be in greater number than the elongated electrodes of the second set.

Still further in accordance with the first aspect of the present disclosure, the elongated electrodes of the first set can for example be grounded.

Still further in accordance with the first aspect of the present disclosure, said voltage can for example be below 30 V_{RMS}.

Still further in accordance with the first aspect of the present disclosure, the plurality of elongated electrodes of the first set can for example be equally spaced from one another.

Still further in accordance with the first aspect of the present disclosure, at least one of the elongated electrodes can for example be made of galvanized steel.

Still further in accordance with the first aspect of the present disclosure, at least one of the elongated electrodes can for example has a cross-sectional diameter of about 3 mm.

Still further in accordance with the first aspect of the present disclosure, the elongated electrodes can for example be parallel to one another within said slab body.

Still further in accordance with the first aspect of the present disclosure, the elongated electrodes of the first set can for example be distributed in a first plane parallel and proximate to the top surface of the slab body and the elongated electrodes of the second set can for example be distributed in a second plane parallel and proximate to the bottom surface of the slab body.

Still further in accordance with the first aspect of the present disclosure, the first and second planes can for example be parallel to one another.

In accordance with a second aspect of the present disclosure, there is provided a method for preventing accumulation of meltable precipitation on a concrete slab having a slab body with a top surface opposed to a bottom surface, the slab body having electrically conductive concrete, and a plurality of elongated electrodes within said slab body, a first set of said elongated electrodes being spaced apart from one another proximate to said top surface and a second set of said elongated electrodes being spaced apart from one another away from said elongated electrodes of the first set, the elongated electrodes of the first set being interspersed with the elongated electrodes of the second set, the method comprising: applying a voltage to the elongated electrodes such that an electrical current propagates obliquely across said slab body, between the elongated electrodes of the first set and the elongated electrodes of the second set, thereby generating heat within said slab body for melting said accumulation.

Further in accordance with the second aspect of the present disclosure, the method can for example comprise, using a meltable precipitation sensor, sensing a presence of said accumulation on said concrete slab; and performing said applying upon said sensing.

Still in accordance with the second aspect of the present disclosure, the method can further comprise performing said applying until said meltable precipitation sensor no longer senses a presence of said accumulation.

Still in accordance with the second aspect of the present disclosure, the method can for example comprise, using a temperature sensor, measuring a temperature value indicative of a temperature of said top surface of said slab body; and performing said applying until said temperature value exceeds a given temperature threshold.

Still in accordance with the second aspect of the present disclosure, said electrical current can for example propagate from the elongated electrodes of the second set to the elongated electrodes of the first set.

In accordance with a third aspect of the present disclosure, there is provided a system for heating a surface, the system comprising: a concrete slab having a slab body with a top surface opposed to a bottom surface, the slab body having electrically conductive concrete; a plurality of elongated electrodes within said slab body, a first set of said elongated electrodes being spaced apart from one another proximate to said top surface and a second set of said elongated electrodes being spaced apart from one another proximate to said bottom surface, the elongated electrodes of the first set being interspersed with the elongated electrodes of the second set; and a voltage source being electrically connected to the elongated electrodes and configured to apply a voltage to said elongated electrodes, thereby generating heat within said slab body.

Further in accordance with the third aspect of the present disclosure, the system can for example further comprise a temperature sensor being configured for measuring a temperature value at said top surface of said slab body; and a controller being communicatively coupled to the voltage source and to the temperature sensor, the controller having a processor and a memory having stored thereon instructions that when executed by the processor cause the voltage source to apply the voltage to said elongated electrodes when said temperature value is below a given temperature threshold.

Still further in accordance with the third aspect of the present disclosure, the elongated electrodes can for example be parallel to one another within said slab body.

Still further in accordance with the third aspect of the present disclosure, the elongated electrodes of the first set can for example be distributed in a first plane parallel and proximate to the top surface of the slab body and the elongated electrodes of the second set can for example be distributed in a second plane parallel and proximate to the bottom surface of the slab body.

Still further in accordance with the third aspect of the present disclosure, the meltable precipitation sensor can for example be a snow/ice sensor.

Still further in accordance with the third aspect of the present disclosure, said meltable precipitation sensor can for example be made integral to said concrete slab, and can for example have a sensing surface being exposed at the top surface of said slab body.

Still further in accordance with the third aspect of the present disclosure, the elongated electrodes of the first set can for example be in greater number than the elongated electrodes of the second set.

Still further in accordance with the third aspect of the present disclosure, the elongated electrodes of the first set can for example be grounded.

Still further in accordance with the third aspect of the present disclosure, said voltage can for example be below 30 V_{RMS}.

Still further in accordance with the third aspect of the present disclosure, the plurality of elongated electrodes of the first set can for example be equally spaced from one another.

Still further in accordance with the third aspect of the present disclosure, at least one of the elongated electrodes can for example be made of galvanized steel.

Still further in accordance with the third aspect of the present disclosure, at least one of the elongated electrodes can for example have a cross-sectional diameter of about 3 mm.

Still further in accordance with the third aspect of the present disclosure, the first and second planes can for example be parallel to one another.

In this disclosure, the term “meltable precipitation” should be construed broadly so as to encompass, but not limited to, snow, ice, graupel, hail and/or any other meltable precipitation.

In this disclosure, the term “parallel” should be construed broadly so as to encompass situations where the parallelism may not be perfect. For instance, the elongated electrodes are said to be parallel to one another. In this context, the term “parallel” can be interpreted such that the elongated electrodes run along one another, without necessarily intersecting one another.

In this disclosure, the term “interspersed” should be construed broadly so as to encompass situations where the interspersing may not be perfect. For instance, the elongated electrodes of the first set are said to be interspersed with the elongated of the second set. In this context, the term “interspersed” can be interpreted such that each elongated electrode of the second set is positioned between two adjacent elongated electrodes of the first set along a given orientation of the slab body. For instance, the term interspersed can be construed so as to exclude situation where elongated electrodes are vertically aligned with one another along the thickness orientation of the slab body.

Many further features and combinations thereof concerning the present improvements will appear to those skilled in the art following a reading of the instant disclosure.

### DESCRIPTION OF THE FIGURES

In the figures,

FIG. 1 is a an oblique view of an example of a system for preventing accumulation of meltable precipitation on a surface, in accordance with one or more embodiments;

FIG. 2 is a schematic view of an example of a computing device of the controller of the system of FIG. 1, in accordance with one or more embodiments;

FIG. 3 is a schematic view of an example of a software application of the controller of the system of FIG. 1, in accordance with one or more embodiments;

FIG. 4A is a schematic view of an example of a formwork for a 30 cm×30 cm concrete slab, with two parallel and opposite corner electrodes at a bottom surface of the formwork, in accordance with the prior art;

FIG. 4B is a schematic view of an example of a formwork for a 30 cm×30 cm concrete slab, with two vertically-spaced apart electrode grids on top and bottom surfaces of the formwork, in accordance with the prior art;

FIG. 4C is a schematic view of an example of a 30 cm×30 cm concrete slab, with parallel elongated electrodes of first and second sets being proximate top and bottom surfaces of the concrete slab, respectively, with the elongated electrodes of the first set being interspersed with the elongated electrodes of the second set, in accordance with one or more embodiments;

FIG. 5A is a schematic view of an example of a formwork for a concrete slab, with parallel elongated electrodes of first and second sets being proximate top and bottom surfaces of the formwork, respectively, with the elongated electrodes of the first set being interspersed with the elongated electrodes of the second set, in accordance with one or more embodiments;

FIG. 5B is a schematic view of the formwork of FIG. 5A, with a socket for a snow/ice sensor, in accordance with one or more embodiments;

FIG. 5C is a schematic view of the formwork of FIG. 5A, with fresh concrete being poured therein, in accordance with one or more embodiments;

FIG. 5D is a schematic view of the formwork of FIG. 5A, inside which a concrete slab is being cured, in accordance with one or more embodiments;

FIG. 6 is a schematic view of the concrete slab of FIG. 5D, with instrumentation and insulation for small-scale tests in an environmental chamber, in accordance with one or more embodiments;

FIG. 7 is a schematic view of the concrete slab of FIG. 5D, in a set-up for thermal expansion measurements, in accordance with one or more embodiments;

FIG. 8 is a schematic view of the concrete slab of FIG. 5D, in an outdoor environment, in accordance with one or more embodiments;

FIG. 9 is a schematic view of a system for preventing accumulation of meltable precipitation on a surface, comprising the concrete slab of FIG. 5D, in accordance with one or more embodiments;

FIGS. 10A-C are graphs showing temperature as function of time for eleven different concrete slabs, in accordance with one or more embodiments;

FIG. 11A is a graph showing energy consumed (EC) as function of heating rate (HR) for eleven concrete slabs, in accordance with one or more embodiments;

FIG. 11B is a graph showing average power consumption (APC) as function of heating rate (HR) for eleven concrete slabs, in accordance with one or more embodiments;

FIG. 12A is a graph showing thermal expansion as function of difference of temperature for a first example concrete slab, in accordance with one or more embodiments;

FIG. 12B is a graph showing thermal expansion as function of difference of temperature for a second example concrete slab, in accordance with one or more embodiments;

FIG. 13A is a graph showing the temperature of the surrounding environment and the temperature of a first example concrete slab over time, in accordance with one or more embodiments;

FIG. 13B is a graph showing the temperature of the surrounding environment and the temperature of a second example concrete slab over time, in accordance with one or more embodiments; and

FIG. 13C is a graph showing the temperature of the surrounding environment and the temperature of a third example concrete slab over time, in accordance with one or more embodiments.

### DETAILED DESCRIPTION

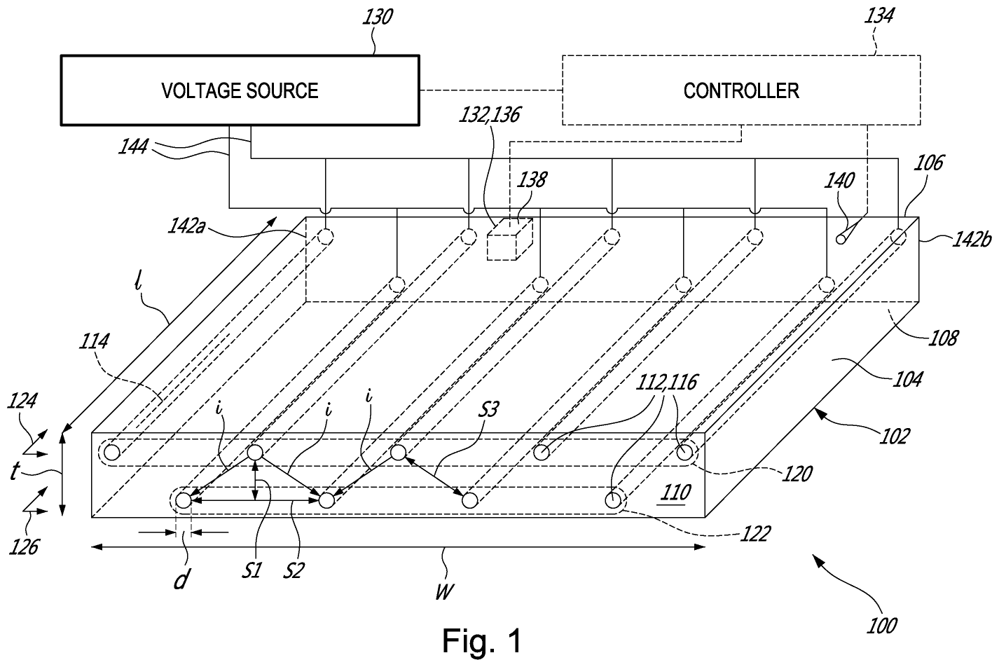

FIG. 1 shows an example of a system 100 for preventing accumulation of meltable precipitation on a surface, in accordance with an embodiment. As depicted, the system 100 has a concrete slab 102 having a slab body 104 with a top surface 106 opposed to a bottom surface 108. In this specific example, the slab body 104 has a rectangular shape with a width orientation w, a thickness orientation t and a length orientation l. However, as can be understood, the slab body 104 can have any other shape including, but not limited to, a triangular shape, a square shape, a rectangular shape, a circular shape, an ovoid shape and any other suitable shape.

The slab body 104 has electrically conductive concrete (ECC) 110. Typically, the electrically conductive concrete 110 includes concrete inside which one or more different type(s) of conductive inclusions are provided. These conductive inclusions can be added to fresh concrete, and mixed therein, prior to pouring into a framework and curing to produce the electrically conductive concrete 110. Examples of such conductive inclusions can include, but not limited to, graphite powder, conductive aggregate, carbon fibre, steel fibre, copper powder, copper coated steel fibers, graphene, carbon powder, steel powder, steel shavings, other carbonaceous materials and any other suitable conductive inclusions.

As shown, the concrete slab 102 has a multitude of elongated electrodes 112 within the slab body 104. In this specific example, the elongated electrodes 112 are parallel to one another. The parallel elongated electrodes 112 are spaced apart from one another both along the thickness orientation t and along the width orientation w of the slab body 104. In this example, the elongated electrodes 112 each have a longitudinal axis 114 extending along the length orientation l of the slab body 104.

As shown, the elongated electrodes 112 are provided in the form of electrode rods 116 and have a cross section with a circular shape. Moreover, in this example, it was found convenient to use elongated electrodes each having a cross-sectional diameter d of about 3 mm. The diameter d of the elongated electrodes 112 can be different from one elongated electrode to another, of from one embodiment to another. For example, the cross-sectional diameter d of the elongated electrodes can be at least 1 mm, at least 3 mm, at least 10 mm or more. As it can be understood, the elongated electrodes can have a cross section with any suitable shape including, but not limited to, triangular, square, rectangular, circular, ovoid and the like, or of any other suitable dimension.

In this example, one or more of the elongated electrodes 112 are made of galvanized steel. In other embodiments, the elongated electrodes 112 can be made of one or more of any other suitable conductive material including, but not limited to, metallic conductors such as silver, copper, aluminum, galvanized steel, carbon coated steel and the like, and non-metallic conductors such as graphite, conductive polymer and the like.

The elongated electrodes 112 include a first set 120 of elongated electrodes 112 which are spaced apart from one another proximate to the top surface 106 of the slab body 104, and a second set 122 of elongated electrodes 112 which are spaced apart from one another away from the elongated electrodes 112 of the first set 120. More specifically, in this specific embodiment, the elongated electrodes 112 of the second set 122 are proximate to the bottom surface 108 of the slab body 104. However, in some other embodiments, the elongated electrodes 112 of the second 122 can be positioned in a middle section of the slab body 104, thereby being no closer from the top surface 106 than from the bottom surface 108 of the slab body 104.

More specifically, in the illustrated embodiment, the elongated electrodes 112 of the first set 120 are parallel to, and spaced apart from one another in, a first plane 124 which is parallel to the top surface 106 of the slab body 104. Similarly, the elongated electrodes 112 of the second set 122 are parallel to, and spaced apart from one another in, a second plane 126 which is parallel to the bottom surface 108 of the slab body 104. The first and second planes 124 and 126 can be parallel to one another.

As illustrated, the elongated electrodes 112 of the first set 120 are interspersed with the elongated electrodes 112 of the second set 122. In other words, the elongated electrodes 112 of the first set 120 are positioned in-between corresponding elongated electrodes 112 of the second set 122 along the width orientation w of the slab body 104, and misaligned with corresponding elongated electrodes 112 of the second set 122 along the thickness orientation t.

In this example, the system 100 has a voltage source 130 which is electrically connected to the elongated electrodes 112 and which is operable to apply a voltage to the elongated electrodes 122, thereby causing electrical currents to propagate from one elongated electrode 112 to another via the electrically conductive concrete 110. As can be understood, the electrically conductive concrete 110 acts as a resistor, and thus generate heat as the electrical currents propagate therein. As can be appreciated, the heat so-generated can in turn melt any accumulation of meltable precipitation on the top surface 106 of the slab body 104.

It was found that the interspersed positions of the elongated electrodes 112 can force the electrical currents to propagate obliquely in the slab body 104, along oblique paths i, from the elongated electrodes 112 of the first set 120 to the elongated electrodes 112 of the second set 122, or vice versa, depending on how the elongated electrodes 112 are electrically connected to the voltage source 130.

Accordingly, the oblique current paths i are longer as they would be if the elongated electrodes 112 were to be vertically aligned with one another, in a manner similar to the hypotenuse of a right triangle being longer than any of its cathethi.

In this way, as longer distances are travelled by the electrical currents along the oblique current paths i, more heat can be generated. In addition, the oblique paths i of the electrical currents were also found to cover more volume of the slab body 104 as they would if the elongated electrodes 112 were to be vertically aligned with one another across the thickness orientation t of the slab body 104, in which case entire portions of the slab body 104 would have no current path therein.

In this example, the system 100 has a meltable precipitation sensor 132 which is configured for sensing a presence of any accumulation of meltable precipitation on the top surface 106 of the slab body 104, and a controller 134 which is communicatively coupled to the voltage source 130 and to the meltable precipitation sensor 132. As such, in this example, the controller 134 is configured to cause the voltage source 130 to apply a voltage to the elongated electrodes 112 upon sensing the presence of an accumulation of meltable precipitation on the top surface 106 of the slab body 104. Accordingly, the system 100 can be activated (or deactivated) based on whether an accumulation of meltable precipitation is present on (or absent from) the top surface 106 of the slab body 104, and thus may consume energy only when required.

In this embodiment, the meltable precipitation sensor 132 is provided in the form of a snow and/or ice sensor, or snow/ice sensor 136. Examples of snow and/or ice sensor include, but not limited to, the Snow/Ice Sensor 090 from Tekmar®, Tekmar 095, ETI CIT-1, ETI SIT-6E, ETI HSC-24, ETI LCD-8, Heatlink 30090, Boschung It-sens, Boschung PWS 500 IR, and Boschung RCO-sensor.

More specifically, the snow/ice sensor 136 shown in this example is made integral to the concrete slab 102. In this case, the snow/ice sensor 136 has a sensing surface 138 which is exposed at the top surface 106 of the slab body 104. Preferably, the sensing surface 138 and the top surface 106 are coplanar with one another. To do so, it was found convenient to position the snow/ice sensor 136 and the elongated electrodes 112 in their respective positions using corresponding framework(s), and to then pour the fresh electrically conductive concrete inside the framework so as to make the snow/ice sensor 136 integral to the concrete slab 102 as the fresh electrically conductive concrete cured.

In some other embodiments, the meltable precipitation sensor 132 can be adjoining to or spaced apart from the concrete slab 102. For instance, the meltable precipitation sensor 132 can be provided in the form of a camera which field of view can encompass at least a portion of the top surface 106 of the slab body 104. In this latter embodiment, the controller 134 has software application to recognize the presence of an accumulation of meltable precipitation on the top surface 106 of the slab body 104. Of course, other types of meltable precipitation sensor can be alternatively used.

In some embodiments, the voltage is applied for a predetermined duration and/or to consume a predetermined amount of electrical energy. However, in the depicted embodiment, the voltage is applied upon sensing the presence of an accumulation on the top surface 106 of the slab body 104 using the meltable precipitation sensor 132. It is also envisaged that the voltage can be applied until the meltable precipitation sensor 132 no longer senses the presence of the accumulation of meltable precipitation.

In alternate embodiments, a temperature sensor 140 such as a thermistor can be mounted to the slab body 104, and in communication with the controller 134, so as to apply the voltage to the elongated electrodes 112 until the temperature sensor 140 measures a temperature value exceeding a predetermined temperature threshold. For instance, a voltage can be applied until the temperature of the slab body 104 is measured to exceed a temperature threshold. An example of such a temperature threshold includes, but is not limited to, about 4° C. In some other embodiments, the voltage can be applied when the temperature of the slab body 104 is measured to be below the temperature threshold.

In the illustrated example, the elongated electrodes 112 of the first set 120 are in greater number than the elongated electrodes 112 of the second set 122, as there are five elongates electrodes 112 in the first set 120 and four elongated electrodes 112 in the second set 122. With such a configuration, the elongated electrodes 112 of the first set 120 can cover a satisfactory portion of the top surface 106 of the slab body 104, which can in turn increase the area of the top surface 106 which is proximate one of the elongated electrodes 112, where heat is mostly generated during use. More specifically, in this example, elongated electrodes 112 of the first set 120 run alongside edges 142a and 142b of the slab body 104, thereby reducing the amount of unheated areas on the top surface 106 of the slab body 104.

It is intended that the voltage source 130 is electrically connected to the elongated electrodes 112 via conductive wires 144. In some embodiments, ends of the conductive wires 144 are soldered, welded or otherwise connected to ends of the elongated electrodes 112. In some other embodiments, ends of the conductive wires 144 are connected to ends of the elongated electrodes 112 via mating connectors (not shown). The electrical connection between the conductive wires 144 and the elongated electrodes 112 can be made prior to pouring the fresh electrically conductive concrete inside the framework(s), so that the electrical connection be within the slab body 104 once the electrically conductive concrete 110 has cured. However, in some other embodiments, the electrical connection between the conductive wires 144 and the elongated electrodes 112 can as well be wholly or partially exposed outside the slab body 104. Wireless current transmission could also be envisaged in some other embodiments.

It was found convenient to ensure that the electrical connection between the voltage source 130 and the elongated electrodes 112 be made such that the elongated electrodes 112 of the first set 120 are grounded. In this way, the perceptibility of the voltage applied between the elongated electrodes 112 when the system 100 is in use can be reduced. Moreover, satisfactory results with a voltage being below 30 V_{RMS} (or equivalently 42.3 Vₚₑₐₖ) were obtained, as described in Example 1 below. In this example, RMS stands for root mean squared.

As the thickness of the slab body 104 is constant in this example, the first and second planes 124 and 126 are parallel to one another and spaced by a first spacing s1. The first spacing s1 can range between about 2 and 30 cm, preferably about 3 and 10 cm and most preferably about 3 and 7 cm. The distance between the first plane 124 and the top surface 106 of the slab body 104 can range between about 0.25 and 10 cm, preferably about 0.5 and 6 cm and most preferably about 0.5 and 3 cm. Similarly, the distance between the second plane 126 and the bottom surface 108 of the slab body 104 can range between about 0.1 and 10 cm, preferably about 0.5 and 5 cm and most preferably about 0.5 and 3 cm. Other spacings could have been alternatively used, depending on the embodiment.

As shown in illustrated embodiment, the elongated electrodes 112 of the first set 120 are equally spaced apart from one another by a second spacing s2 in the width orientation w, and the elongated electrodes 112 of the second set 122 are equally spaced apart from one another by the second spacing s2 in the width orientation w. The second spacing s2 can range between about 10 and 40 cm, and most preferably about 15 and 30 cm.

As shown, a third spacing s3 can be defined along the oblique orientation between an electrode of the first set 120 and an adjacent electrode of the second set 122. The third spacing s3 between the electrodes located in a zig-zag pattern can govern the electrical resistance of the system 100, which is proportional to the thickness t of the slab body 104. Thus, to maintain the same heat efficiency, the third spacing s3 between an electrode of the first set 120 and an electrode of the second set 122 can range between about 2 and 50 cm, preferably about 3 and 30 cm and most preferably about 4 and 15 cm. The preceding values can be determined based on the first and second spacings s1 and s2 discussed above using basic trigonometry. It is noted that in most applications the thickness of the slab body 104 can range between about 2 and 30 cm, and most preferably between about 5 cm and 20 cm.

It is noted that in the illustrated embodiment, the first spacing s1 is about 5 cm, the second spacing s2 is about 28 cm, the distance between the top surface 106 and the first plane 124 is less than 0.5 cm, the distance between the bottom surface 108 and the second plane 126 is less than 0.5 cm. However, in some other embodiments, the first spacing s1 could reach up to 100 cm, the second spacing s2 could reach 20 cm, whereas the distances between the top and bottom surfaces 106 and 108 and the nearest one of the first and second planes 124 and 126 can go up to about 5 cm.

Based on several laboratory tests, the illustrated zig-zag electrode configuration can allow to reduce the power electrical consumption to heat a concrete slab from −9° C. to 5° C. from 4000 W/m² to about 700 W/m² in less than 1 hour time.

Moreover, in this example, as the elongated electrodes 112 of the second set 122 are positioned at a middle position between two adjacent elongated electrodes 112 of the first set 120 along the width orientation w, the oblique spacing s3 between the elongated electrodes 112 of the first set 120 and the elongated electrodes 112 of the second set 122 is constant throughout the slab body 104. Such a configuration can contribute to evenly distribute the heat generated by the elongated electrodes 112 when the voltage is applied. In some other embodiments, however, the density of elongated electrodes 112 can be increased near edges 142a and 142b of the slab body 104 so as to compensate for thermal losses near the edges 142a and 142b.

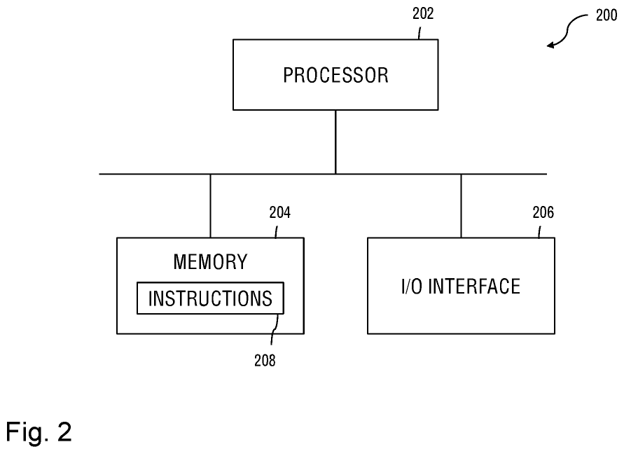

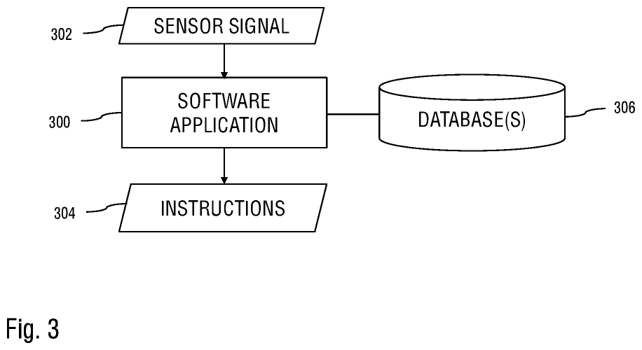

The controller 134 can be provided as a combination of hardware and software components. The hardware components can be implemented in the form of a computing device 200, an example of which is described with reference to FIG. 2. Moreover, the software components of the controller 134 can be implemented in the form of a software application 300, an example of which is described with reference to FIG. 3.

Referring to FIG. 2, the computing device 200 can have a processor 202, a memory 204, and I/O interface 206. Instructions 208 for controlling the voltage source 130 and/or for monitoring the meltable precipitation sensor 132 can be stored on the memory 204 and accessible by the processor 202.

The processor 202 can be, for example, a general-purpose microprocessor or microcontroller, a digital signal processing (DSP) processor, an integrated circuit, a field programmable gate array (FPGA), a reconfigurable processor, a programmable read-only memory (PROM), or any combination thereof.

The memory 204 can include a suitable combination of any type of computer-readable memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like.

Each I/O interface 206 enables the computing device 200 to interconnect with one or more input devices, such as the meltable precipitation sensor 132, the temperature sensor 140 and the like, or with one or more output devices such as the voltage source 130 and/or a user interface.

Each I/O interface 206 enables the controller 134 to communicate with other components, to exchange data with other components, to access and connect to network resources, to serve applications, and perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these.

Referring now to FIG. 3, the software application 300 is configured to receive sensor signal 302 from the meltable precipitation sensor 132 which is indicative of the presence or absence of an accumulation of meltable precipitation on the top surface 106 of the slab body 104, and to determine output instructions 304 upon processing the sensor signal 302. In some cases, the output instructions 304 cause the voltage source 130 to apply the voltage to the elongated electrodes 112, increase the voltage, decrease the voltage and/or even stop the application of the voltage to the elongated electrodes 112. In this specific embodiment, the software application 300 is stored on the memory 204 and accessible by the processor 202 of the computing device 200. The software application 300 can have access to one or more internal or external databases 306 used for storing calibration data such as temperature thresholds. For instance, in this case, the temperature threshold value of 4° C. discussed above is stored on the database(s) 306.

The computing device 200 and the software application 300 described above are meant to be examples only. Other suitable embodiments of the controller 134 can also be provided, as it will be apparent to the skilled reader.

### Example 1—Thermal-Electrical Behavior of Prefabricated ECC Slabs with Integrated Sensor System

As several types of ECC have been developed to heat a slab by joule effect by passing an electrical current across it. In general, the addition of conductive inclusions (e.g., steel fiber, graphite powder) in ECC can allow reducing the electrical resistivity to a value lower than 100 Ohm*cm, which was found to be effective. The overall electrical resistance of the ECC slab can depend on the material ECC conductivity, but also and the section and length of the concrete material along the current path between the electrodes. Previous work have employed different disposition of electrodes, such as: on two L-shaped electrodes on the external edges of the slab, two steel plates electrodes vertically embedded in the concrete slab, or two layer of squared mesh made of steel. No work has attempted to optimize the position of electrodes for achieving an efficient heating system and reducing the risk of system loss of efficiency due to cracking (e.g., due to concrete shrinkage).

Conventional de-icing methods with salts and snow removal engender considerable maintenance cost and consequential corrosion of the reinforced concrete infrastructures. As alternative, heating systems based on Electrically Conductive Concrete (ECC) have been lately developed to reduce operational and reparation costs. The aim of this example is to develop an optimized prefabricated ECC slab with a safe level of electrical current, integrated snow/ice sensors, and a satisfactory energy consumption.

The two-step methodology consisted of: (i) small-scale slab tests in an environmental controlled chamber to optimize the electrodes configuration and the slab thickness; (ii) a sensor-controlled prototype at large-scale in real field conditions. The 2 ECC mix designs employed in this study were characterized by a resistivity under 300 Ω-cm. The best-performing small-scale ECC slab was able to heat from −9° C. to 5° C. in a controlled temperature of −9° C. in less than 60 minutes with an average consumption of about 700 W/m². Notably, the ECC system can work with an applied voltage of 30 VRMS which can insure the electrical safety of users. Finally, the developed ECC system was tested in a real-scale with an integrated snow/ice sensor connected to a controller that can minimize energy consumption under 400 W/m². The ECC prototype was successful for different scenarios as snow storm, ice-rain formation and imposition of 9 cm of compacted snow, which simulates a black-out situation.

The two different ECC mix designs used in this study were developed after previous researches, which combined different conductive inclusions, such as graphite powder (GP), conductive aggregate (CA), carbon fiber (CF), steel fiber (SF), copper powder (CP), copper coated steel fibers (CuSF) and the like, within a cementitious matrix to obtain an economic ECC mix-design with a suitable resistivity for de-icing applications, i.e., lower than 1000 Ω-cm. As general result, GP and CA showed the best results for conductivity as aggregates, while CF presented the best results as fibers. However, CuSF were chosen in this example for their low supply cost. The use of graphene has also been justified due to its effect on conductivity. Table 1 summarizes the mix proportion of ECC mix design #1. The water-to-cement (w/c) ratio was 0.46. Considering densities provided by raw materials' providers, the volumetric fraction of GP, CuSF, CA and Graphene were 6%, 2%, 10% and 0.05%, respectively.

Conventional de-icing methods with salts and snow removal engender considerable maintenance cost and consequential corrosion of the reinforced concrete infrastructures. As alternative, heating systems based on Electrically Conductive Concrete (ECC) have been lately developed to reduce operational and reparation costs. The aim of this example is to develop an optimized prefabricated ECC slab with a safe level of electrical current, integrated snow/ice sensors, and a satisfactory energy consumption.

TABLE 1
Mix design #1 - properties and content.

| | | Density | | Content |
|---|---|---|---|---|
| Material | Size/Type | (g/cm³) | Additional information | (kg/m³) |
| Coarse | 2.5-10 mm | 2.7 | Crushed limestone | 268.5 |
| aggregates | | | | |
| Fine aggregates | <2.5 mm | 2.7 | Natural sand | 540 |
| Cement | White Portland | 3.2 | Federal white cement | 649.9 |
| | cement type GU | | | |
| Water | Demineralized water | 1.0 | — | 300 |
| Superplasticizer | Type A/F ASTM | 1.0 | Euclid Plastol 341 | 17.2 |
| | C494 | | | |
| Graphite powder | 90% of particles < | 2.2 | Natural | 132 |
| (GP) | 38 μm | | | |
| Copper Coated | L = 13 mm | 7.9 | Steel wire fibers | 157.3 |
| Steel fibers | d = 200 μm | | | |
| (CuSF) | | | | |
| Conductive | D < 5 mm | 2.0 | FurseCEM ™ | 204 |
| aggregates (CA) | | | | |
| Graphene | 150 nm < d < 10 μm | 2.2 | Nanosheets | 1.1 |
| Isopropyl alcohol | 70% USP | | Used to disperse | 1.1 |
| | | | Graphene | |

Note:
coarse and fine aggregate are in saturated surface dry condition.

Table 2 summarizes the mix proportion of ECC mix design #2. The water-to-cement (w/c) ratio was 0.45. Considering densities provided by raw materials' providers, the volumetric fraction of GP and SF were 6% and 2%, respectively.

TABLE 2
Mix design #2 - properties and content.

| | | Density | Additional | Content |
|---|---|---|---|---|
| Material | Size/Type | (g/cm³) | information | (kg/m³) |
| Coarse | 2.5-10 mm | 2.7 | Crushed limestone | 537 |
| aggregates | | | | |
| Fine aggregates | <2.5 mm | 2.7 | Natural sand | 540 |
| Cement | White Portland | 3.2 | Federal white | 649.9 |
| | cement type GU | | cement | |
| Water | Demineralized water | 1.0 | — | 294.3 |
| Superplasticizer | Type A/F ASTM | 1.0 | Euclid Plastol 341 | 23.6 |
| | C494 | | | |
| Graphite powder | 90% of particles < | 2.2 | Natural | 132 |
| (GP) | 38 μm | | | |
| Steel fibers (SF) | L = 13 mm d = 200 μm | 7.9 | Steel wire fibers | 157.3 |

A total of 10 small-scale slabs were produced with a surface of 30 cm×30 cm with 3 different configurations in terms of thickness and patterns of electrodes, as follows.

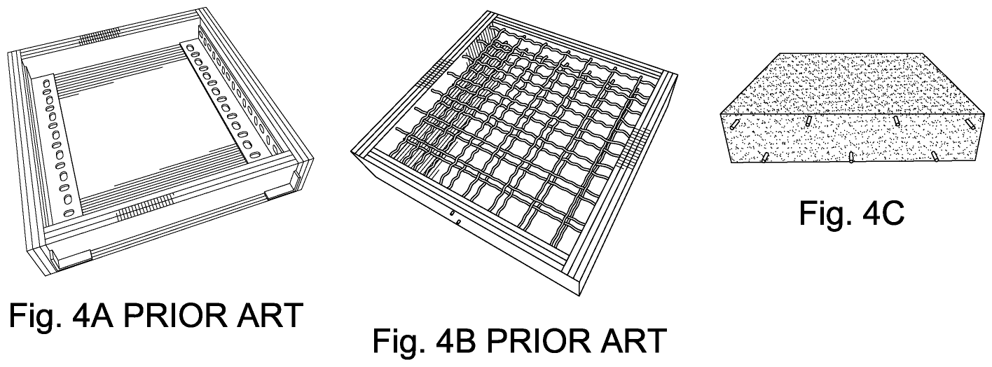

The configuration #1, shown in FIG. 4A, employed 2 L-channel (3.75 cm×3.75 cm×3 mm) made of galvanized steel with gaps larger than the maximum aggregates size. One side of the formwork was cut to be able to install the electrode with an extra length to allow the electrical connection with the external supply.

The configuration #2 is shown in FIG. 4B which consists of two grids placed in parallel and horizontal plans. The mesh and spacing varied from one slab to another, but the diameter of all rods was 3 mm. The grid inter-distance was assured by means of small pieces of wood. The side of the formwork was drilled to allow the electrical connection with the external supply.

The configuration #3 is shown in FIG. 4C consists of parallel galvanized steel wire of diameter of about 3 mm. The schematic view shows a slab once casted. This configuration allows to find the optimal slab resistance, which can generate enough heat for de-icing the slab with a maximum voltage supply of 30 V.

All parameters of the tested slabs are presented in Table 3.

The mix designs were mixed with a laboratory homemade pan mixer with rotating tank with the following mixing sequence: (i) the dry ingredients (aggregates, cement, CA and GP) were mixed for 5 minutes; (ii) water and superplasticizer were then added in about 1 minute 30 seconds; (iii) once the mix was rather fluid, graphene dispersed in isopropyl alcohol making a viscous paste, as recommenced by furnisher, was incorporated in about 1 minute in the mixer; (iv) the fibers were then added and mixed for 3 minutes, and (v) the mix was casted. For slabs with L-channel electrodes, the formworks were filled with a large aluminum scoop and put on a vibrating table for about 2 minutes. For slabs with grids as electrodes, the grid below was first installed and the formwork was filled up with ECC with a large aluminum scoop to the height of the top grid. The second grid was then installed, and the covering of ECC was poured. Slabs were then put on a vibrating table for about 2 minutes. For slabs with electrode configuration #3, 2 minutes on vibrating table were also needed to fill the slab mold. At least 2 cylindrical specimens of 100 mm diameter and 200 mm height were also molded at each casting to test the electrical resistivity and the compressive strength at 28 days to make sure the mixing process has been done correctly. Cylinders were also put on a vibrating table for about 2 minutes.

All slabs and cylinders were protected for 48 hours with a wet blanket in ambient air. After demolding, they were placed 5 days in a 100% relative humidity room at about 23° C. They were then placed in an accelerated cure in water at about 70° C. for 3 days, which is called thermal treatment (TT). Cylinders were then stored at 100% RH until they reach the age of 28 days while slabs were tested the day after the end of the TT. The heat treatment accelerates the hydration rate of cement, which provides better compressive and tensile resistance, as well as reduced shrinkage and creep. The accelerated reaction is also beneficial to stabilize the electrical conductivity.

The small-scale slab configurations are summarized in Table 3. For group 1, Slab #1 and #2 were made with different thickness with the same electrodes in each end. Slab #3 is the same that slab #2, but with a 1.3 cm thick overlay of Ultra High-Performance Concrete (UHPC) to see its influence on thermal and electrical behavior. Thickness, mesh and electrode spacing were varied for the 5 slabs of group 2. The configuration of group 3, which consists in parallel rods, have been installed with an offset between the top and the bottom to augment the distance between electrodes. The current was then flowing diagonally between the top and the bottom. The number of electrodes varied between the 3 samples, and the number is presented in parenthesis in electrode type column. The distance of the diagonal is also shown in Table 3.

As general remark, the position of electrodes in the horizontal of configurations #2 and #3 has the advantage that all ECC slabs with same thickness have same electrical current and Joule effect independently from the surface of the slab. Moreover, the electrical current is less affected by possible vertical cracks as the current direction is mainly in the vertical direction.

TABLE 3
Small-scale slabs configuration.

| | Slab | Thickness | ECC Mix | Electrode | Mesh | Electrode |
|---|---|---|---|---|---|---|
| Configuration | # | (cm) | design | type | (cm) | spacing (cm) |
| #1 | #1 | 5.1 | 1 | L-channel | N.A. | 30 |
| | #2 | 3.8 | 1 | L-channel | N.A. | 30 |
| | #3 | 3.8* | 1 | L-channel | N.A. | 30 |
| #2 | #4 | 5.1 | 1 | Parallel Grids | 3.2 | 2 |
| | #5 | 5.1 | 1 | Parallel Grids | 3.2 | 3.1 |
| | #6 | 5.1 | 1 | Parallel Grids | 5.1 | 4.2 |
| | #7 | 7.6 | 1 | Parallel Grids | 3.2 | 6.4 |
| | #8 | 7.6 | 1 | Parallel Grids | 5.1 | 6.4 |
| #3 | #9 | 5.1 | 2 | Rods (3) | N.A. | 16 |
| | #10 | 5.1 | 2 | Rods (5) | N.A. | 9 |
| | #11 | 5.1 | 2 | Rods (7) | N.A. | 7 |

Note:
N.A. = Not applicable,
*= with 1.3 cm of UHPC overlay.

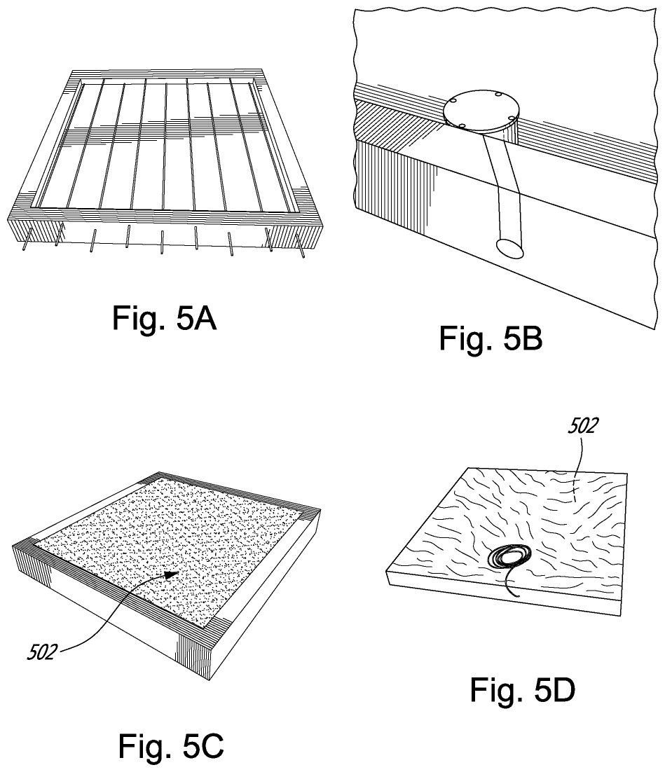

In order to test an automated system in real North American winter conditions, a real scale prototype slab has been constructed and installed on the campus of Laval University. Mix design #2 has been used with electrode configuration as slab #9. The casting and mixing procedure was the same sequence as small-scale slabs. A formwork with a surface of 1.08 m×1 m and a thickness of 5.1 cm was built with extruded polystyrene insulation of 5.1 cm of thickness, as shown in FIG. 5A. The formwork was installed on a wooden pallet with a minimum slope for water drainage and easy transportation. A socket for the snow/ice sensor was installed in the bottom part of the slab as shown in FIG. 5B. After pouring the ECC concrete with a large aluminum scoop, the formwork was put on a vibrating table for about 10 minutes as shown in FIG. 5C. The vibration time was longer considering the visible low viscosity of ECC mix design and the weight of the slab. The ECC slab surface was finished with a metal trowel to form concrete slab 502. A wet blanket was put on the surface of the slab for 48 hours, and a wet curing blanket was installed on the surface for 12 days until the installation outside, as shown in FIG. 5D. The blanket was rewetted every day to avoid drying.

Four cylindrical specimens of 100 mm of diameter and 200 mm of height were also casted to test the electrical resistivity and the compressive strength at 28 days to verify the ECC resistivity ρ. The ECC cylinders were put on a vibrating table for about 2 minutes. They were demolded at 48 hours as the slab, and stored for 26 days in a 100% RH room at 23° C.

The electrical resistivity and mechanical properties of the two mix designs used in this study were measured on cylinders after having a heat tempered curing at 7 days (70° C. for 72 hours) and being stored at 100% RH at 23° C. until the age of 28 days. The ECC cylinders were cut using a concrete saw and were grinded on both sides. Electrical resistivity measurements were made using a concrete bulk electrical resistivity testing device, which is commercially available under the name Giatec RCON2™. The concrete cylinder is placed between two parallel electrodes. A wet sponge and conductive gel were applied at each end of the cylinders to insure a good contact with electrodes. An alternate current (I) source aliments the electrodes at different frequencies. The potential drop (ΔV) is measured, and the resistance (R) is calculated with the Ohm's law:

ΔV=R·I. (1)

The electrical resistivity p is then calculated with the equation ρ=R·L/A, where L is the distance between two adjacent electrodes and A is the transversal section (in cm²). The machine gives the value of electrical resistivity, in Ω-m, for a cylindrical sample measuring 203.2 mm of height and 101.6 mm of diameter. Each specimen was measured 10 times (5 times diameter and 5 times height). A correction factor was applied to consider the effective diameter and height of the cylinder sample. Mechanical properties measurements were made using a 5000 kN hydraulic press. Cylinders used for these tests were the same than those used for electrical resistivity measurements, with parallel surfaces due to the end grinding. All the compressive strength tests were made in accordance with ASTM Standard C39 at a loading rate of 2000 N/s which corresponds to 0.25 MPa/s. Splitting tensile strength tests were conducted in accordance with ASTM Standard C496.

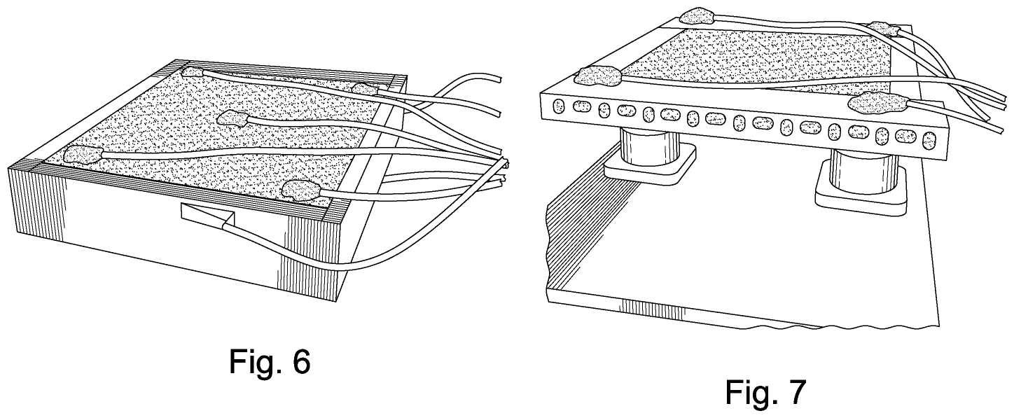

To test the small-scale slabs of 30 cm×30 cm, an environmental cabinet of 16 cubic feet was used to reproduce low temperatures of winters. Slabs were insulated with 2.5 cm of rigid extruded polystyrene with a RSI of 0.88 to maximize the heat release by the top and reduce to the minimum the heat losses by the edges and the bottom, as shown in FIG. 6. The small slabs were instrumented with 6 thermistors of 5 kΩ at 25° C. to follow the thermal behavior at 5 emplacements on the top (each corner and center) and 1 below the slab in the insulation. Thermistors were insulated with a thick asbestos-free duct seal compound to avoid being influenced by the ambient temperature of the cabinet. Another thermistor was installed on the side of the insulation to see if heat was released by the edges. Finally, a thermistor was free in the cabinet to record the ambient temperature. A rheostat of a maximum power of 1 kVA with adjustable tension was used to provide electricity to system. Two multimeters were also part of the system. One in parallel with the slab to measure the exact voltage and one in series to measure the current. Tests were conducted at an ambient temperature of −9° C., which is considered ideal temperature for the most heavy snowfalls.

As for the calibration of the thermistors, the Steinhart-Hart's equation, see equation (2), for the resistance of a semiconductor at different temperatures has been used to convert measurements from thermistors to temperature:

$$\frac{1}{T} = A + B ln ( R ) + {C [ ln ( R ) ]}^{3} , \qquad ( 2 )$$

where T is the temperature (° C.), R is the electrical equivalent resistance (Ω) and A, B, C are the Steinhart-Hart coefficients, who are determined by resolving the following matrix with 3 operating points provided by the furnisher:

$$( \begin{matrix}1 & ln ( {R}_{1} ) & {ln}^{3} ( {R}_{1} ) \\ 1 & ln ( {R}_{2} ) & {ln}^{3} ( {R}_{2} ) \\ 1 & ln ( {R}_{3} ) & {ln}^{3} ( {R}_{3} )\end{matrix} ) ( \begin{matrix}A \\ B \\ C\end{matrix} ) = ( \begin{matrix}1 \text{/} {T}_{1} \\ 1 \text{/} {T}_{2} \\ 1 \text{/} {T}_{3}\end{matrix} ) \qquad ( 3 )$$

For the thermistors used in this study, coefficients A, B and C were respectively 1.08×10⁻⁷, 2.37×10⁻⁴ and 1.47×10⁻³.

A hand-made setup was elaborated to estimate the thermal expansion of the slab as presented in FIG. 7. The small ECC slabs of 30 cm×30 cm were mounted on 4 spherical supports to allow a free expansion. Fixed brass markings were glued to the surface of the slab with epoxy resistant to high temperature in the direction parallel to the electrodes and in the direction perpendicular to the electrodes. 5 thermistors were installed on the slab: 4 on each corner of the top and 1 below at the center. The slab temperature was monitored in real time and an expansion measurement was taken with a mechanical strain gauge with a precision of 0.001 mm at each temperature difference of about 10° C. Tests were conducted on slabs #1 and #2 because no material was restricting the movement inside the slab, which gave a value for the material.

The thermal expansion coefficient was calculated with Equation (4):

$$α = \frac{Δ L}{{L}_{0} \cdot Δ T} , \qquad ( 4 )$$

where L₀ is the original length, ΔL is the difference between each length measurement and L₀ and ΔT is the temperature difference with the initial temperature. The average of the temperature read by the 5 thermistors was used for the ΔT calculations.

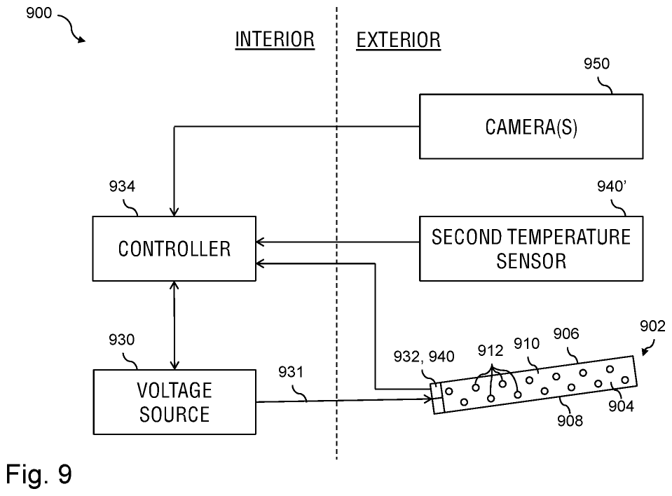

FIG. 9 shows an example of a system 900 for preventing accumulation of meltable precipitation on a surface. As shown, the system 900 has a concrete slab 902 which has a slab body 904 with a top surface 906 opposed to a bottom surface 908. The slab body 904 has electrically conductive concrete 910. The slab body 904 has an area of 1.08 m² in this embodiment. The concrete slab 902 was installed on the campus at more than 5 m of a building wall. This distance was chosen to avoid the absence of wind that would not be representative of reality. As depicted, and described above, first and second sets of elongated electrodes 910 are within the slab body 904, with the elongated electrodes 912 of the first set being proximate to the top surface 906 and the elongated electrodes 912 of the second set being proximate to the bottom surface 908. The elongated electrodes 912 of the first and second sets are also interspersed with one another in a zig-zag manner.

As shown, the system 900 has a voltage source 930 which is electrically connected to the elongated electrodes 912 and which is operable to apply a voltage to the elongated electrodes 912, thereby generating heat within the slab body 904 for melting any accumulation on the top surface 906. As shown in this example, while the concrete slab 902 may be positioned outdoor, the voltage source 930 may be indoor, electrically connected to the elongated electrodes 912 via conductive wires 931. In this example, the voltage source 930 includes a 4:1 AC transformer, which converts 120 V to 30 V. Two coils are also installed to monitor the tension and current in the 4:1 transformer over time.

As shown, the system 900 has a snow/ice sensor 932 which can sense accumulation of meltable precipitation on the top surface 906. The snow/ice sensor 932 itself generates heat, which melts snow when a flake touches its surface and the surface moisture level is measured, which indicates the presence of snow on the slab 904. A controller 934 is also provided. The controller 934 is communicatively coupled in a wired and/or wireless fashion to the voltage source 930 and to the snow/ice sensor 932. Accordingly, the controller 934 can cause the voltage source 930 to apply a voltage to the elongated electrodes 912 upon sensing presence of snow/ice on the top surface 906 of the slab body 904 using the snow/ice sensor 932.

In this embodiment, first and second temperature sensors 940 and 940′ are provided, both of which are communicatively coupled to the controller 934. More specifically, the first temperature sensor 940 is mounted to the slab body 904 to monitor the temperature of the slab body 904 over time. More specifically, the first temperature sensor 940 is integrated within the slab body 904 at 2.5 cm of the top surface 906. The first temperature sensor 940 is proximate to the snow/ice sensor 932. The first temperature sensor 940 can measure between −46 and 40° C. In this embodiment, the second temperature sensor 940′ is remote from the concrete slab 902 and thereby monitors temperatures of the environment surrounding the concrete slab 902. For instance, the second temperature sensor 940′ was installed on a fence nearby.

In this example, the system 900 also has a camera 950 which generates images of the top surface 906 of the concrete slab 902 over time. As such, the generated images can be processed using the controller 934. The controller 934 in this example is communicatively coupled to the voltage source 930 as well. In some embodiments, the camera 950 and the controller 934 can act as a snow/ice sensor as images can be processed to determine the presence or absence of meltable accumulation on the top surface 906 of the slab body 904.

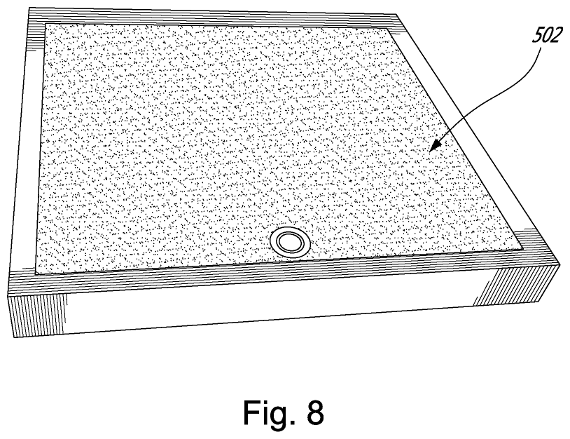

A LabView programming ran on the controller 934 allowed calculating the power consumed by the concrete slab 902 at all times. A melting set point was set equal to 3° C. The controller 930 was also operated with a LabView programming via the controller 934. When the snow is detected by the snow/ice sensor 932, a signal is sent to the controller 934 and in function of the outdoor temperature as measured by the second temperature sensor 940′, the needed internal temperature of the slab is calculated, and the electrical transformer imposes the tension of 30 V. When the melt set point is reached, the controller 934 calculates the energy required to maintain this temperature for 20 minutes cycles. This energy is calculated as a percentage of minutes powered per cycle. Once the surface is considered dry by the snow/ice sensor 932, the slab body 904 temperature is kept for 4 hours. This technique is programmed in the commercial Tekmar® 680 controller 930 to minimize energy consumption. Moreover, the camera 950 was installed to follow the de-icing and snow removal behavior in real time by taking high definition pictures each 30 seconds. A picture of the slab installed is shown in FIG. 8.

Three events were analyzed which were registered after the installation of the ECC prototype after March 2018, as described in the following paragraphs.

Case #1: The first real-scale test was conducted on Mar. 21, 2018. A thickness of 7.5 cm of snow was manually compacted on the surface of the slab. The snow from the last storm has been stored in a freezer until the moment of the test. The external temperature ranged from −12° C. to 3° C. with a test duration of 7 hours. This scenario could happen, for example, if an electricity breakdown occurs during a snowfall and then the accumulated snow would need to be melted.

Case #2: The second real-scale experimentation was conducted on Apr. 4, 2018. About 5 cm of snow naturally accumulated on the ground in the presence of moderately strong winds. The external temperature ranged from −5° C. to −3° C. with a test duration of 10 hours.

Case #3: The third real-scale test took place on Apr. 16, 2018. Freezing rain and snowfall occurred this day. The external temperature ranged from −2.5° C. to 0.5° C. with a test duration of 12 hours.

The electrical resistivity and mechanical properties at 28 days of the two mix designs used in this study are presented in Table 4. Both mix designs meet the criteria for de-icing applications, which is being under 1000 Ω-cm. Their resistivity is almost 4 times lower than the threshold, which is very satisfying. Their compressive strength and splitting tensile strength are also satisfying, with typical values of vibrated ordinary Portland cement concrete.

TABLE 4
Electrical resistivity and mechanical properties of mix designs.

| | Electrical | Compressive | Splitting |
|---|---|---|---|
| | resistivity | strength | tensile strength |
| Mix design | (Ω-cm) | (MPa) | (MPa) |
| 1 | 260 | 28.2 | 4.0 |
| 2 | 268 | 35.2 | 4.5 |

The objective of this phase was to minimize the electrical consumption under 1000 W/m² by using a minimum electrical tension for safety. The tension used, average power consumption, heating rate and energy consumed of slabs #1 to #11 are presented in Table 5. The Heating Rate (HR) was conventionally estimated as the mean heating rate between −6° C. and 0° C. The Energy Consumption (EC) to bring the ECC slab from −6° C. to 0° C. was calculated as well as the power supply by considering the time from passing from −6° C. to 0° C. The Average Power Consumption (APC) presented in the table below was calculated by an average between −6° C. and 0° C. and reported to 1 m².

For the first group of configurations, the tension needed to be high to be able to heat. For the second group, the tension was low, but the energy consumption was high. For the third group, the tension was satisfying and the energy consumption of one of the 3 slabs was satisfying.

TABLE 5
Tension, energy, average power consumption and heating rate of every slab.

| | | | Average | | |
|---|---|---|---|---|---|
| | | | Power | | Energy |
| | | Tension | consumption | Heating rate | Consumption EC |
| Configuration | Slab # | (V) | (W/m²) | (° C./min) | (kJ/m²) |
| 1 | 1 | 100 | 3813 | 0.97 | 1387 |
| | 2 | 100 | 3900 | 1.47 | 953 |
| | 3 | 100 | 2205 | 0.51 | 1576 |
| 2 | 4 | 16 | 1642 | 0.35 | 1716 |
| | 5 | 16 | 1662 | 0.28 | 1863 |
| | 6 | 16 | 1595 | 0.31 | 1843 |
| | 7 | 16 | 1532 | 0.22 | 2482 |
| | 8 | 16 | 1768 | 0.19 | 3332 |
| 3 | 9 | 30 | 713 | 0.12 | 2012 |
| | 10 | 30 | 2698 | 0.34 | 2901 |
| | 11 | 30 | 2322 | 0.76 | 1114 |

As for configuration #1, a 100 V was applied with high power consumption. The slab #2 had the higher heating rate but was also the most energetically demanding. The use of a layer of UHPC reduced the homogenized conductivity of slab #3, which resulted in a decrease of the power consumption but also of the heating rate. The voltage at the surface of slabs #1 and #2 was found to be about 90% of the input voltage. The surface voltage was only 10% of the input voltage for Slab #3 as the UHPC overlay showed effective results for electrical insulation. Slabs of configuration #2 exhibited satisfactory heating rate with a reduced supply voltage of 16 V, but the power consumption was still too high. Interestingly, for this electrode configuration, the voltage at the surface was nearly 0 since the neutral component of the AC current was positioned near the surface. For configuration #3, slabs #10 and #11 also had a satisfactory heating rate with a reduced supply voltage of 30 V, but the power consumption was still too high. According to initial objectives of the small-scale slabs phase, the best performing slab is slab #9 because it uses a low tension and it consumes the less energy.

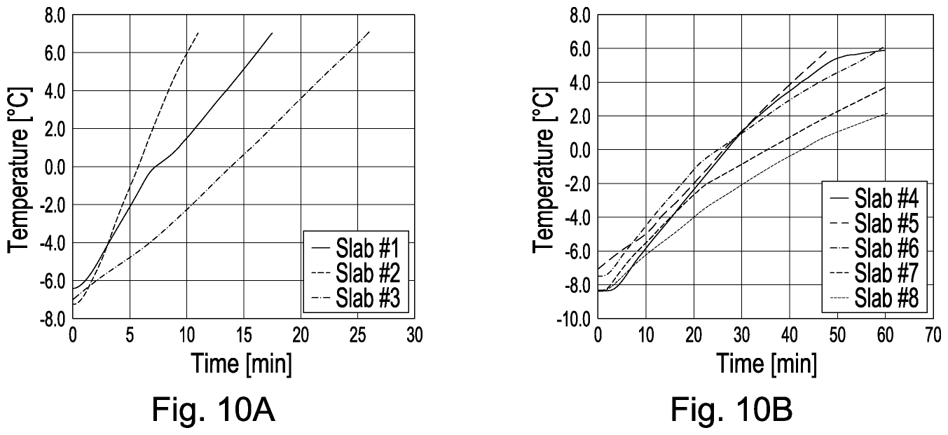

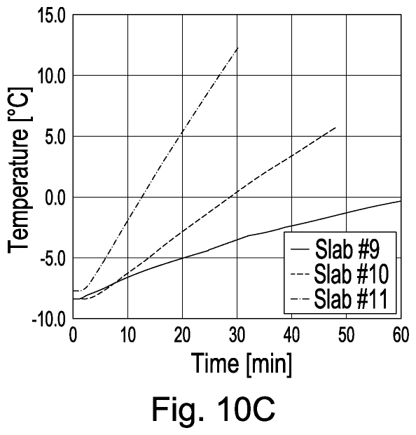

Thermal behavior of slabs of group 1 are presented in FIG. 10A. The augmentation of temperature is almost linear. Slab #3 took more than twice the time than slab #2 to exceed 6° C., and slab #1 was between both. However, as mentioned previously, the voltage and power consumption of the 3 slabs of group 1 were too high.

Thermal behavior of slabs of group 2 are presented in FIG. 10B. Curves also look almost linear. Slab #5 reached 6° C. in less than 50 minutes, while slabs #4 and #6 took 60 minutes and slabs #7 and #8 did not reach 6° C. after 60 minutes of heating. As the slabs of group 1, the power consumption of slabs of group 2 was too high according to established criteria.

Thermal behavior of configuration #3 are presented in FIG. 10C. The temperature vs time curves look rather linear. Slab #9 passed from −9° C. to 0° C. after 60 minutes of heating. Electrode spacing has been optimized for this slab to allow reasonably rapid heating with decreased voltage while consuming less energy. With respect to slab #9, slab #10 heats twice faster and slab #11, 4 times faster, but both have an excessive power consumption. For this configuration, the tension at the surface was around 20 V, which represents no danger to users because the associated current for a human body would not even be perceptible. The configuration of the electrodes of slab #9 was then chosen to use in the prototype construction.

The thermistor installed on the side of the insulation (not shown in results) showed that no heat was released by the edges of the insulation, as found by previous searchers.

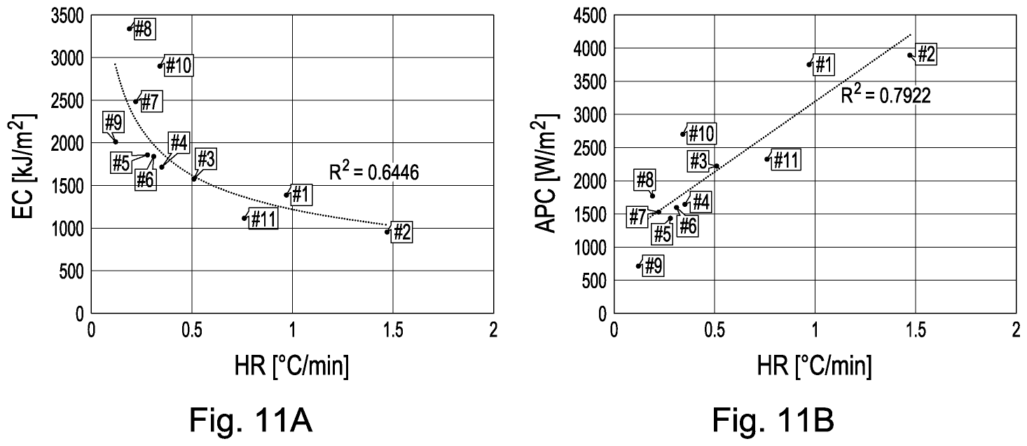

A correlation was attempted by plotting the energy consumed (EC) in function of heating rate (HR), shown in FIG. 11A. It is not possible to affirm that there is a direct correlation between these 2 elements (the R² is poor), but there is an easily observable tendency. The R² is probably reduced by slab #10, which is relatively far from the trend line. From this point of view, the most effective slab would be slab #2, this configuration did not meet the initial objectives of this research, who were using a low tension and having a power consumption lower than 1000 W/m². Again, the most satisfying slab is slab #9 because of his low average power consumption and because it uses less than 30 V. The impossibility to correlate EC and HR is probably due to heat losses by interstices between concrete, because the contact was not always perfect. To avoid this problem in large-scale experimentations, concrete was casted directly in the insulation. FIG. 11B presents the average power consumption in function of heating rate. The average electrical consumption threshold established by the searchers is presented on this figure. According to this criterion, as said many times, the most effective slab is slab #9. A proportional tendency is clearly visible between the average power consumed and the heating rate, even if the R² is poor. This means that the heating rate is almost directly related to the power consumed. This correlation is interesting to consider when applications are being developed. Indeed, for places where the snow must be melted quickly, a configuration of electrodes which provides more energy to the slab could be used. For locations where slower response and slight snow accumulation is acceptable, a less energy consuming electrodes setup could be used.

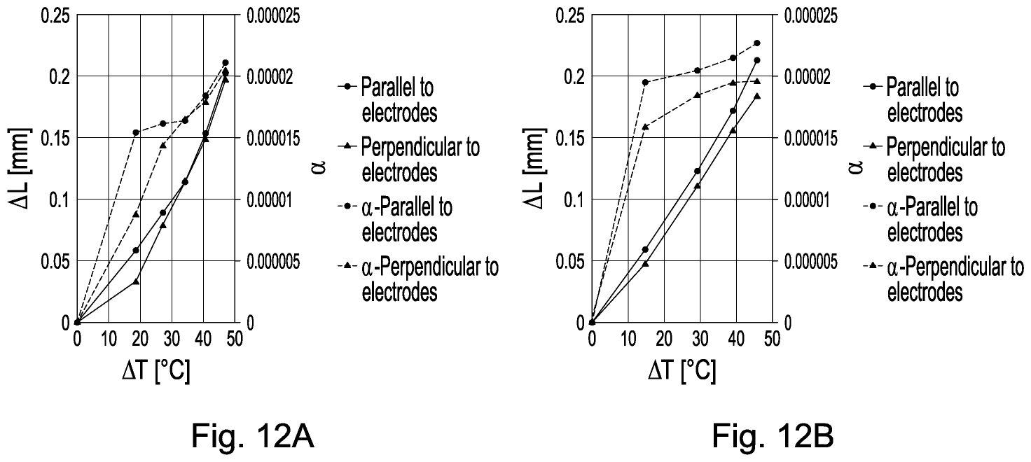

The thermal expansion results are presented in FIG. 12A, with the length variation on the left y-axis and the α coefficient calculated at each ΔT on the right y-axis. For slab #1 (Erreur ! Source du renvoi introuvable), the thermal expansion parallel to electrodes after a difference of almost 50° C. is nearly the same than perpendicular. The thermal expansion is about 0.10% in both senses. For slab #2 (FIG. 12B), the expansion parallel to electrodes is higher than the expansion perpendicular to electrodes. This higher expansion could be explained by the fact that the thermal expansion of galvanized steel electrodes pushed the concrete to expand more. However, the difference is slim, less than 0.03 mm after a temperature difference of nearly 50° C. The thermal expansion is about 0.10% parallel to electrodes and 0.09% perpendicular to electrodes.

The average thermal expansion coefficient calculated between −5° C. and 45° C. with equation (4) are presented in Table 6. The α coefficient was calculated at each ΔT, and the average coefficient was calculated thereafter. The difference between coefficient parallel to electrodes and perpendicular to electrodes was 11% for slab #1 and 13% for slab #2. The lower thickness of the slab is probable the cause of the higher difference for slab #2. The average thermal expansion coefficient is higher in both cases for the sense parallel to electrodes perhaps due to the thermal expansion of galvanized steel electrodes.

TABLE 6
Average thermal expansion coefficient of slabs #1 and #2.

| | Parallel to electrodes | Perpendicular to electrodes |
|---|---|---|
| Slab # | (° C.⁻¹) | (° C.⁻¹) |
| 1 | 17.5 × 10⁻⁶ | 15.6 × 10⁻⁶ |
| 2 | 21.0 × 10⁻⁶ | 18.4 × 10⁻⁶ |

Table 7 below presents the conditions, average outdoor temperature, duration and average consumption of the large-scale slab in the context of 3 different cases aforementioned. The case #1 exhibited the highest energy consumption due to the lower outdoor temperature and the manual imposition of 7.5 cm of snow on the surface. The case #2 had the lower energy consumption, which is obvious. Even if the outdoor temperature of the event who occurred on 2018 Apr. 16 was higher than the one who occurred on 2018 Apr. 4, the average energy consumption was higher.

TABLE 7
Recapitulative snow removal and de-icing operations results and details.

| | Average | | | | |
|---|---|---|---|---|---|
| | outdoor | Duration of | Average | Initial | Final |
| | temperature | the test | consumption | temperature | Temperature |
| Case | (° C.) | (hours) | (W/m²) | (° C.) | (° C.) |
| #1 | −5.9 | 7.0 | 525 | −2 | 4.5 |
| #2 | −4.0 | 10.0 | 309 | 6 | 2 |
| #3 | −0.6 | 12.0 | 324 | 3 | 4.5 |

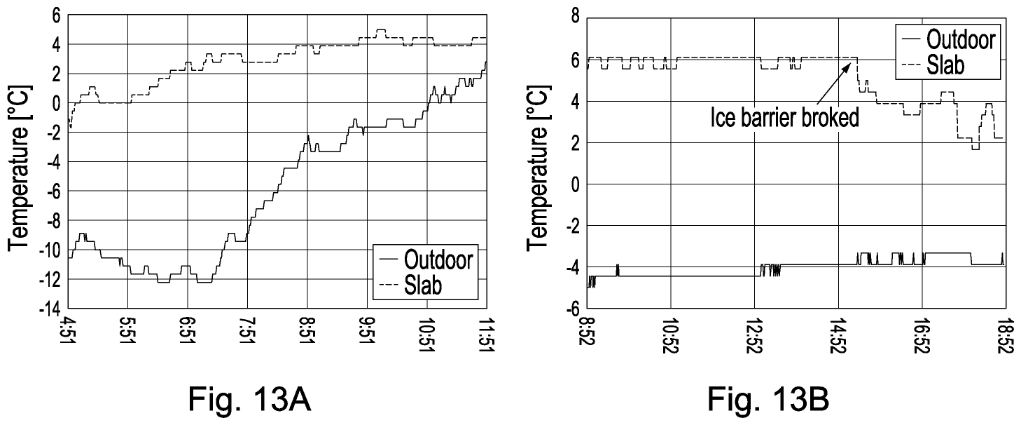

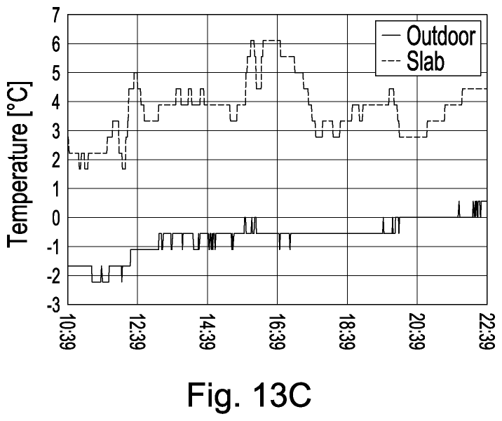

The slab internal temperature and outdoor temperature in function of time of the case #1 are presented in FIG. 13A. 7.5 cm of snow were added at the surface of the slab at the beginning of the test. Almost a third of the test took place at less than −10° C., which explains the high average consumption of the first test. More energy was needed to keep the surface at the melt set point temperature. It took about 2 hours to the slab to reach the melt set point temperature of 3° C. The 7.5 cm of snow, which was manually compacted on the surface was melt in 7 hours, which corresponds to a melting rate of a little over a centimeter of snow per hour.

FIG. 13B shows internal temperature and outdoor temperature in function of time for case #2. An unexpected ice hem was formed above the unheated external frame of the slab blocking the water resulting from the melting of snow from drowning. Thus, water started accumulating on the surface and the upper part froze. Above the ECC slab, there was a thin film of unfrozen water covered by a thick layer of ice of about 2 cm. The surface of the slab was at a temperature above 0° C. because of the unfrozen film of water. This kind of event would not happen in a real application since an unheated perimeter would be avoided. When the ice barrier on the external unheated side of the ECC slab was removed at 15:20, the water film was drained, and the ice layer entered in contact with the ECC surface. The layer of ice that formed was melted in less than 4 hours despite the continuous snow fall.

FIG. 13C shows internal temperature and outdoor temperature in function of time for case #3, which showed the lower energy consumption. Pictures taken by the camera showed that no ice accumulated on the slab surface during the freezing rain showers who occurred during the day. This test validated the effectiveness of the snow/ice sensor in presence of freezing rain. This is an advantage of the developed system since climate change statistics show that there will be a trend towards increased temperatures and precipitation, which will increase the frequency of freezing rain.

In summary, this example was aimed at developing electrodes to make ECC safe for users with a low energy consumption. Developed electrodes were then tested in a larger scale automated slab with sensors. Based on the present results, the following conclusions can be drawn. Firstly, an electrode configuration has been developed during small-scale slab tests, using 30 V and consuming less than 700 W/m². This configuration also provides a satisfying heating rate at the surface of slabs. Secondly, the energy consumed by the slab doesn't dictate the heat release by the slab. There is no direct correlation between heating rate and energy consumed for the tested slabs. However, there is a proportional trend between the average power consumed and the heating rate. Thirdly, the average thermal expansion coefficient for slabs #1 and #2 was higher in the sense parallel to electrodes than perpendicular to electrodes, probably due to the expansion of electrodes pushes the ECC to expand more in this sense. Finally, the electrode configuration developed during small-scale slab tests was successfully implemented in a real-scale slab prototype installed on the campus of Laval University. The use of a controller allowed to minimize the energy consumption. For the 3 scenarios tested, the average power consumption was 386 W/m². The snow/ice sensor was proven efficient in presence of freezing rain. A more critical scenario was also tested, i.e. the reproduction of an electrical breakdown.

As can be understood, the examples described above and illustrated are intended to be exemplary only. For instance, although the illustrated embodiments show a plurality of elongated electrodes in the second plane, proximate the bottom surface of the slab body, the other embodiments of the system can alternatively have only one elongated electrode in the second set. The scope is indicated by the appended claims.

1. A system for preventing accumulation of meltable precipitation on a surface, the system comprising:
a concrete slab having a slab body with a top surface opposed to a bottom surface, the slab body having electrically conductive concrete;
a plurality of elongated electrodes within said slab body, a first set of said elongated electrodes being spaced apart from one another proximate to said top surface and a second set of said elongated electrodes being spaced apart from one another away from said elongated electrodes of the first set, the elongated electrodes of the first set being interspersed with the elongated electrodes of the second set; and
a voltage source being electrically connected to the elongated electrodes and being operable to apply a voltage to said elongated electrodes, an electrical current thereby propagating through the electrical conductive concrete obliquely across said slab body, between the elongated electrodes of the first set and the elongated electrodes of the second set and generating heat within said slab body for melting said accumulation on said top surface.

2. The system of claim 1 further comprising:
a meltable precipitation sensor being configured for sensing said accumulation of meltable precipitation on said top surface; and
a controller being communicatively coupled to the voltage source and to the meltable precipitation sensor, the controller having a processor and a memory having stored thereon instructions that when executed by the processor cause the voltage source to apply the voltage to said elongated electrodes upon said sensing.

3. The system of claim 2 wherein the meltable precipitation sensor is a snow/ice sensor.

4. The system of claim 2 wherein said meltable precipitation sensor is made integral to said concrete slab, and has a sensing surface being exposed at the top surface of said slab body.

5. The system of claim 1 wherein the elongated electrodes of the first set are in greater number than the elongated electrodes of the second set.

6. The system of claim 1 wherein the elongated electrodes of the first set are grounded.

7. The system of claim 1 wherein said voltage is below 30 V_{RMS}.

8. The system of claim 1 wherein the plurality of elongated electrodes of the first set are equally spaced from one another.

9. The system of claim 1 wherein at least one of the elongated electrodes is made of galvanized steel.

10. The system of claim 1 wherein at least one of the elongated electrodes has a cross-sectional diameter of about 3 mm.

11. The system of claim 1 wherein the elongated electrodes are parallel to one another within said slab body.

12. The system of claim 1 wherein the elongated electrodes of the first set are distributed in a first plane parallel and proximate to the top surface of the slab body and the elongated electrodes of the second set are distributed in a second plane parallel and proximate to the bottom surface of the slab body.

13. The system of claim 12 wherein the first and second planes are parallel to one another.

14. A method for preventing accumulation of meltable precipitation on a concrete slab having a slab body with a top surface opposed to a bottom surface, the slab body having electrically conductive concrete, and a plurality of elongated electrodes within said slab body, the method comprising:
with a first set of said elongated electrodes being spaced apart from one another proximate to said top surface and a second set of said elongated electrodes being spaced apart from one another away from said elongated electrodes of the first set, the elongated electrodes of the first set being interspersed with the elongated electrodes of the second set,
applying a voltage to the elongated electrodes such that an electrical current propagates obliquely across said slab body, between the elongated electrodes of the first set and the elongated electrodes of the second set, thereby generating heat within said slab body for melting said accumulation.

15. The method of claim 14 further comprising:
using a meltable precipitation sensor, sensing a presence of said accumulation on said concrete slab; and
performing said applying upon said sensing.

16. The method of claim 15 further comprising:
performing said applying until said meltable precipitation sensor no longer senses a presence of said accumulation.

17. The method of claim 14 further comprising:
using a temperature sensor, measuring a temperature value indicative of a temperature of said top surface of said slab body; and
performing said applying until said temperature value exceeds a given temperature threshold.

18. The method of claim 14 wherein said electrical current propagates from the elongated electrodes of the second set to the elongated electrodes of the first set.

19. A system for heating a surface, the system comprising:
a concrete slab having a slab body with a top surface opposed to a bottom surface, the slab body having electrically conductive concrete;
a plurality of elongated electrodes within said slab body, a first set of said elongated electrodes being spaced apart from one another proximate to said top surface and a second set of said elongated electrodes being spaced apart from one another proximate to said bottom surface, the elongated electrodes of the first set being interspersed with the elongated electrodes of the second set; and
a voltage source being electrically connected to the elongated electrodes and configured to apply a voltage to said elongated electrodes, an electrical current thereby propagating through the electrical conductive concrete obliquely across said slab body, between the elongated electrodes of the first set and the elongated electrodes of the second set and generating heat within said slab body.

20. The system of claim 19 further comprising:
a temperature sensor being configured for measuring a temperature value at said top surface of said slab body; and
a controller being communicatively coupled to the voltage source and to the temperature sensor, the controller having a processor and a memory having stored thereon instructions that when executed by the processor cause the voltage source to apply the voltage to said elongated electrodes when said temperature value is below a given temperature threshold.

21. (canceled)

22. (canceled)
